(19) United States
(12) Patent Application Publication
(10) Pub. No.: US 2015/0345530 A1
(43) Pub. Date: Dec. 3, 2015

(54) POLE FOOT

(71) Applicant: COMMERCIAL SEWING, INC., Torrington, CT (US)

(72) Inventors: Michael E. Hissong, Torrington, CT (US); Brian M. Delisle, Barkhamsted, CT (US); David J. Mazzarelli, Torrington, CT (US); Stephen S. Mazzarelli, Torrington, CT (US)

(21) Appl. No.: 14/724,895

(22) Filed: May 29, 2015

Related U.S. Application Data
(60) Provisional application No. 62/005,457, filed on May 30, 2014.

(51) Int. Cl. F16B 9/02; B60J 7/00

(52) U.S. Cl. CPC F16B 9/02; B60J 7/0084

(57) ABSTRACT

A pole foot is provided including a pole foot base having a first contact surface and a second opposing surface. A pole receiver extends substantially perpendicularly from the second opposing surface. The pole receiver includes a first wall configured to receive a support pole. A width of the pole foot base is substantially larger than a width of the support pole.

### CROSS-REFERENCE TO RELATED APPLICATION

This application claims the benefit of U.S. provisional patent application Ser. No. 62/005,457 filed May 30, 2014, the entire contents of which are incorporated herein by reference.

### BACKGROUND

Exemplary embodiments of the present invention relate generally to a cover configured for use with a transportation vehicle, and more particularly, to an anti-pooling system used to support the cover of a transportation vehicle.

Many transportation vehicles, such as power boats for example, utilize a canvas or fabric cover to protect at least the interior of the vehicle from the elements, thereby enabling the vehicle to be stored outside. When the cover becomes wet, the cover tends to sag and lose the necessary slope required for proper drainage. As a result, water often collects or pools in the sagging or depressed areas of the cover. In many instances, the collected water becomes fairly large and heavy making removal of the cover, and therefore the water difficult. In addition, these large pools of water sometimes have sufficient weight to tear the cover.

To avoid water collecting on the cover, upwardly bowed stays or supports, such as having a plurality of straps for example, are often removably mounted to the vehicle underneath the cover. The supports and straps are intended to retain the cover in a desired position to limit the potential for water accumulation on the cover. However, installation and removal of the supports and any straps extending therefrom may be cumbersome. In addition, the mounting connecting the support pole to an interior surface of the transportation vehicle may damage the transportation vehicle.

### SUMMARY

According to an embodiment of the invention, a pole foot is provided including a pole foot base having a first contact surface and a second opposing surface. A pole receiver extends substantially perpendicularly from the second opposing surface. The pole receiver includes a first wall configured to receive a support pole. A width of the pole foot base is substantially larger than a width of the support pole.

According to another embodiment of the invention, an anti-pooling system configured to support a cover is provided including a support pole and a first pole foot mounted to a first end of the support pole. The first pole foot includes a pole foot base having a first contact surface and a second opposing surface. A pole receiver extends substantially perpendicularly from the second opposing surface. The pole receiver includes a first wall configured to receive a support pole. A width of the pole foot base is substantially larger than a width of the support pole.

### BRIEF DESCRIPTION OF THE FIGURES

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary transportation vehicle including an anti-pooling system according to an embodiment of the invention;

FIG. 2 is another perspective view of an exemplary transportation vehicle including an anti-pooling system according to an embodiment of the invention

FIG. 3 is a perspective view of a pole foot of the anti-pooling system according to an embodiment of the invention;

FIG. 4 is a top view of a pole foot according to an embodiment of the invention;

FIG. 5 is a detailed view of the pole receiver within section B of FIG. 3 according to an embodiment of the invention;

FIG. 6 is a bottom view of a pole foot according to an embodiment of the invention;

FIG. 7 is a cross-sectional view of the pole foot taken along line A-A of FIG. 4 according to an embodiment of the invention;

FIG. 8 is a detailed section view of the pole foot within section C of FIG. 5 according to an embodiment of the invention;

FIG. 9 is a cross-sectional view of the pole foot take alone line D-D of FIG. 4 according to an embodiment of the invention;

FIG. 10 is a top view of a pole foot according to an embodiment of the invention;

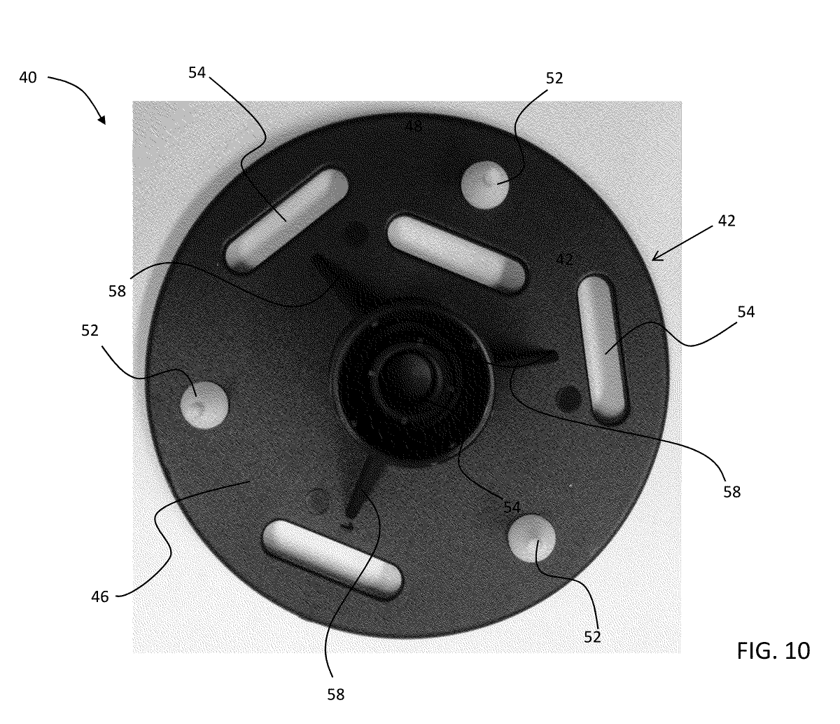

FIG. 11 is a bottom view of a pole foot according to an embodiment of the invention; and

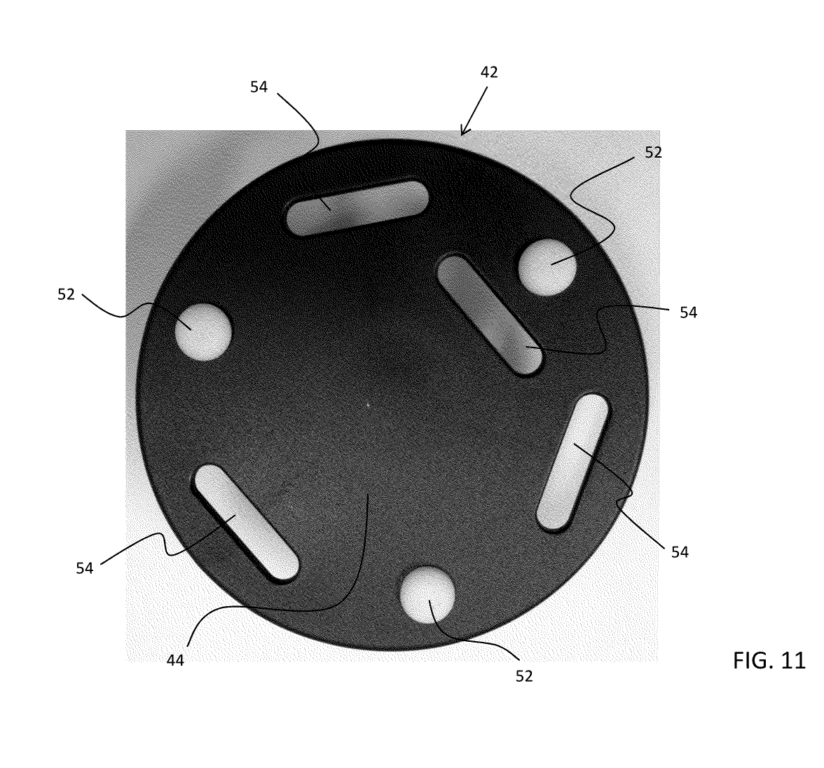

FIG. 12 is a cross-sectional view of a portion of an anti-pooling system according to an embodiment of the invention.

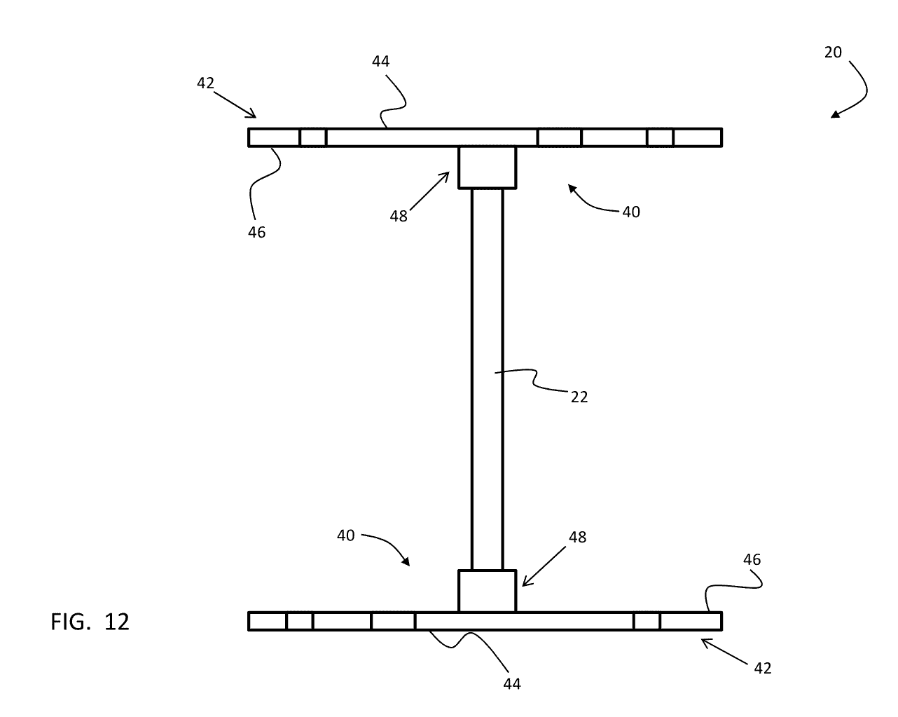

The detailed description explains embodiments of the invention, together with advantages and features, by way of example with reference to the drawings.

### DETAILED DESCRIPTION

The following disclosure will detail particular embodiments according to the present invention, which provides a pole foot, and more particularly a pole foot of an anti-pooling system configured for use with transportation devices. Reference is now made to the drawings, wherein like reference numerals are used to refer to like elements throughout the disclosure.

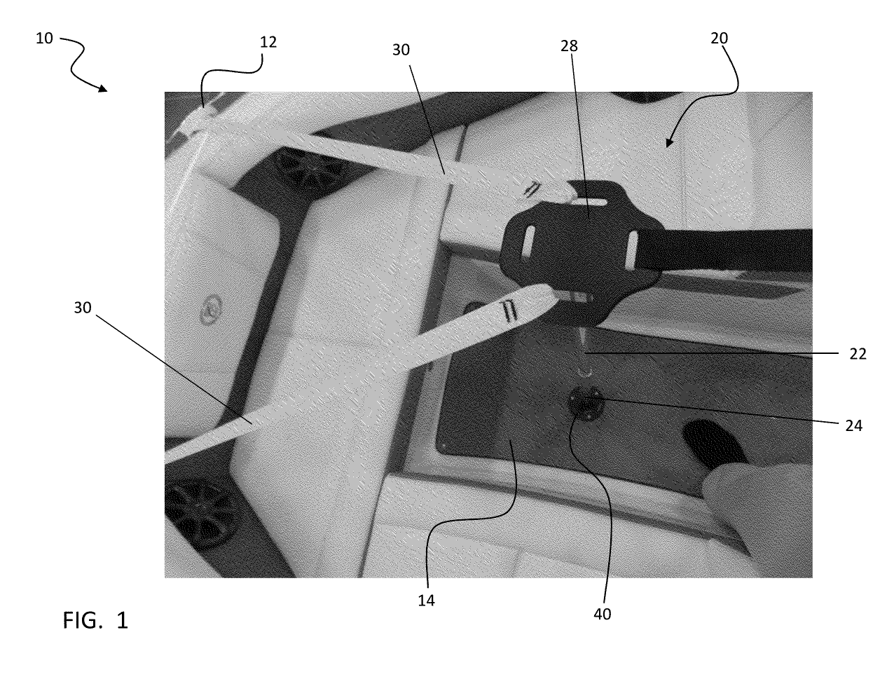

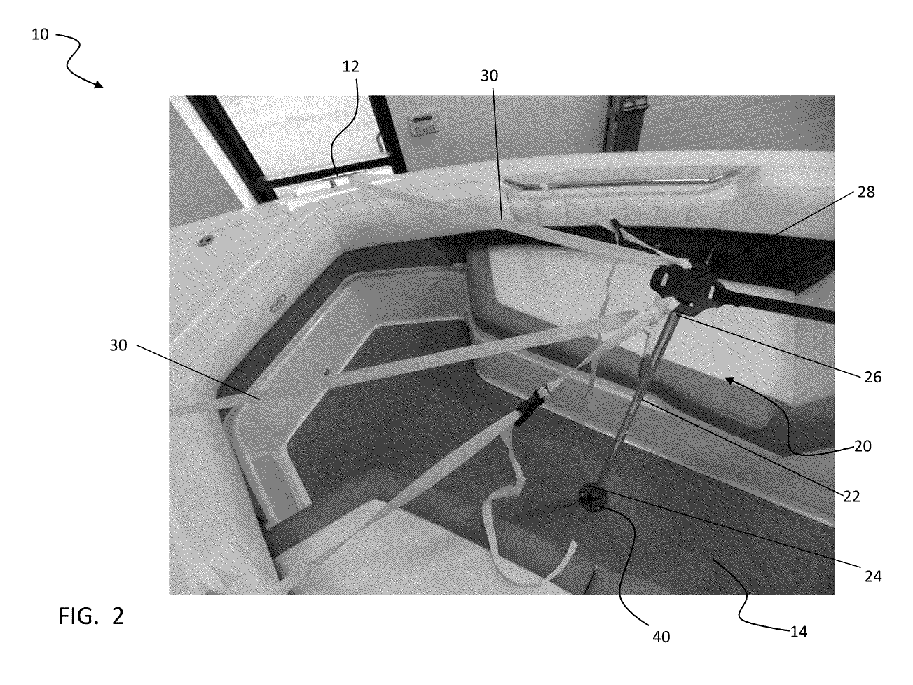

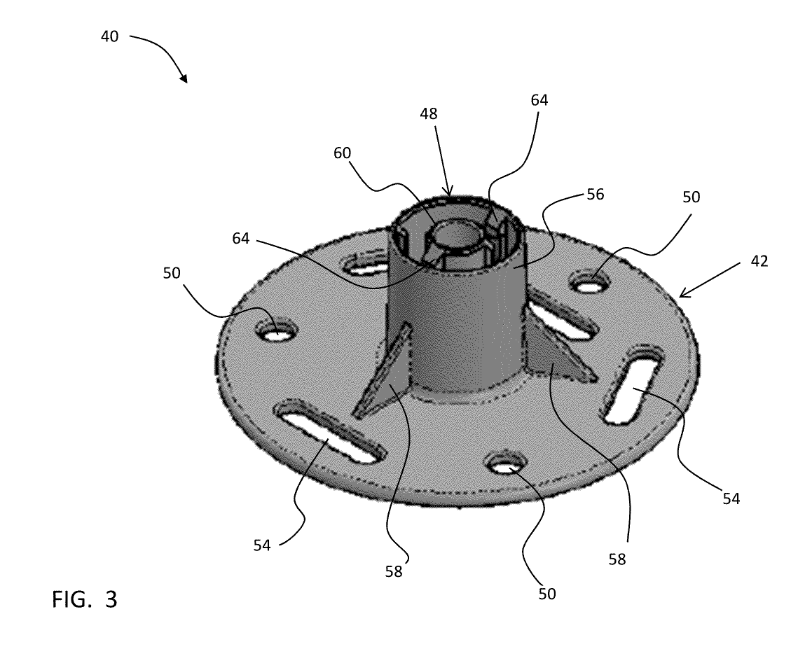

Referring to FIGS. 1-2, a transportation vehicle 10, such as a boat for example, including an anti-pooling system 20 is illustrated. The anti-pooling system 20 includes at least one support pole 22 configured to mount at a first end 24 (FIG. 3) to the floor of the boat 10. Rigidly mounted at the second, opposite end 26 of the pole 22 is a webbing attachment device 28. Multiple webbing straps 30 extend from a plurality of elevated, central attachment points (not shown) formed in the webbing attachment device 28 and are configured to connect to a plurality of peripheral attachment points 12 located at various positions of the boat 10. When the webbing straps 30 are deployed in such a manner, the webbing straps 30 and the at least one support pole 22 provide an underlying structure for supporting a cover (not shown). The positioning of the support pole 22 and the webbing straps 30 retain the cover in a desired position to prevent pooling of water on the top surface thereof. When the cover is not deployed, the anti-pooling system 20 may be removed and stored.

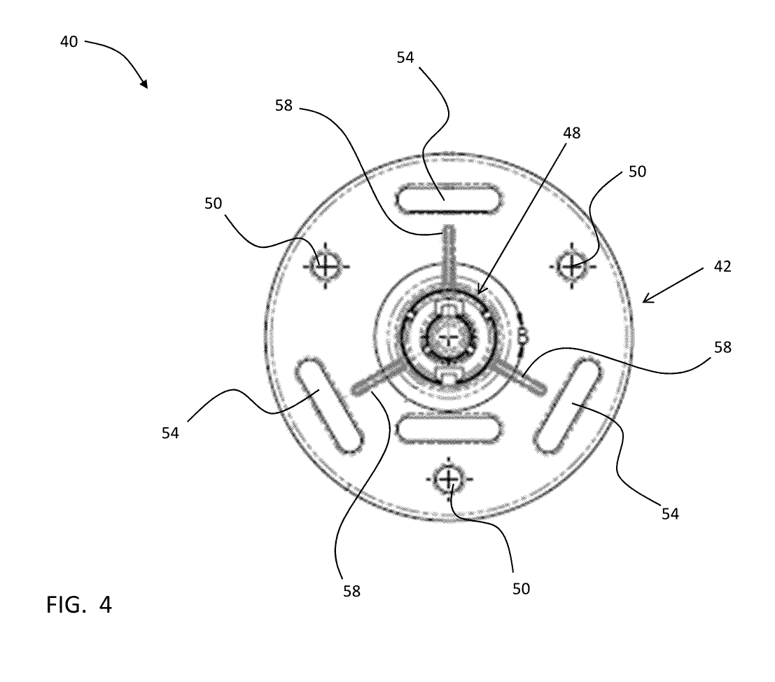

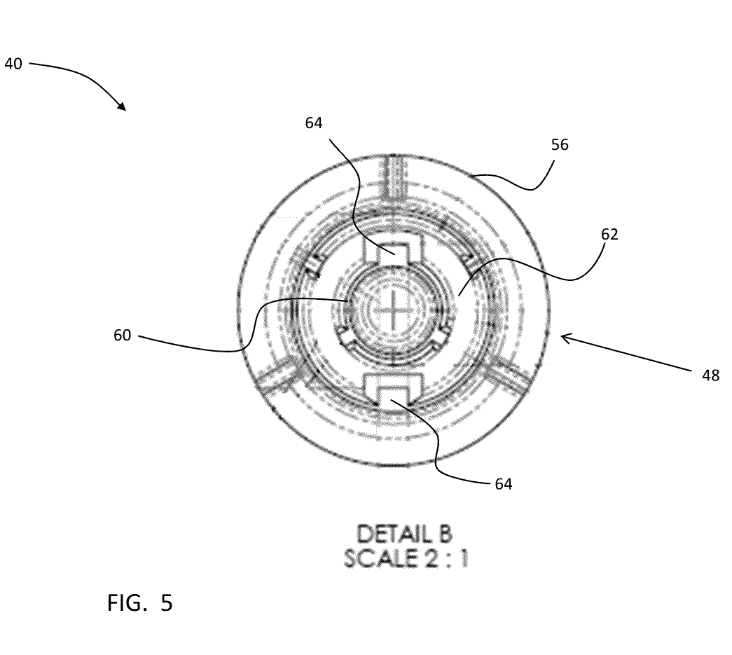

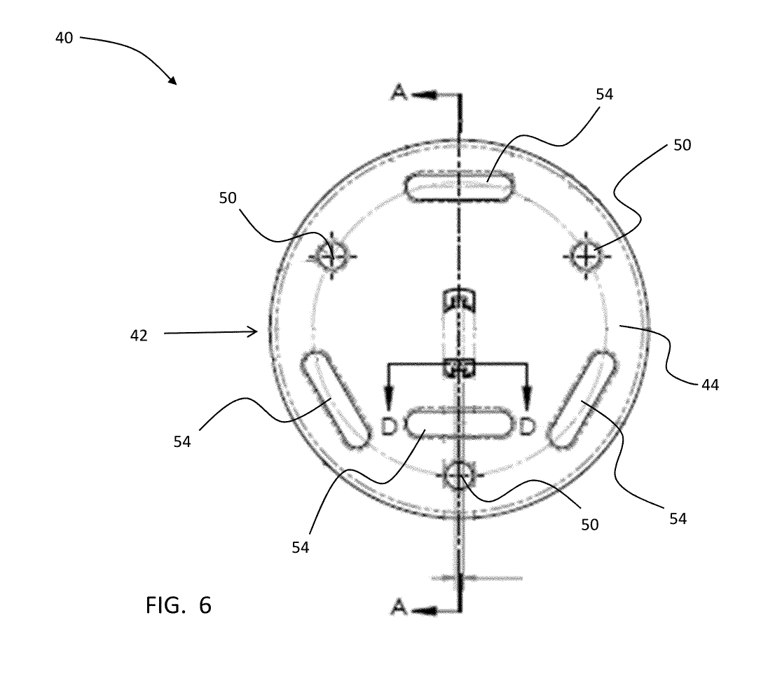

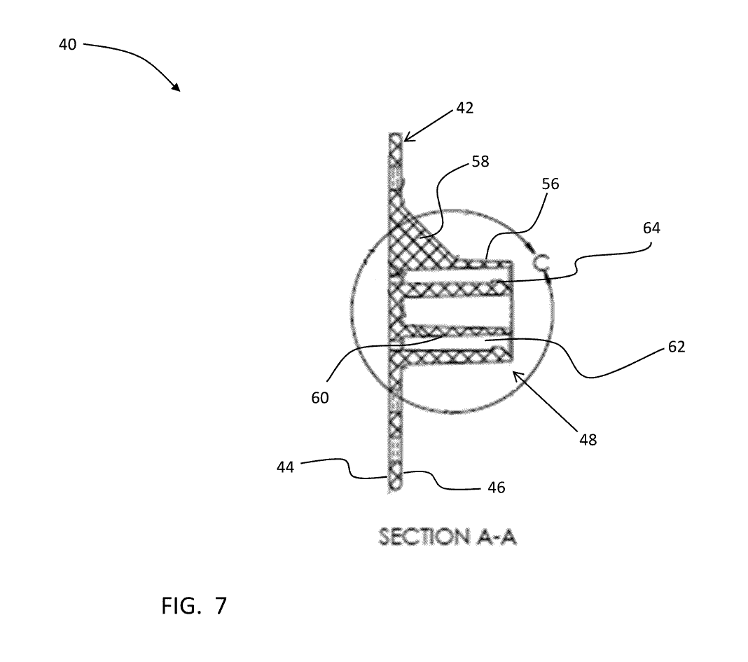

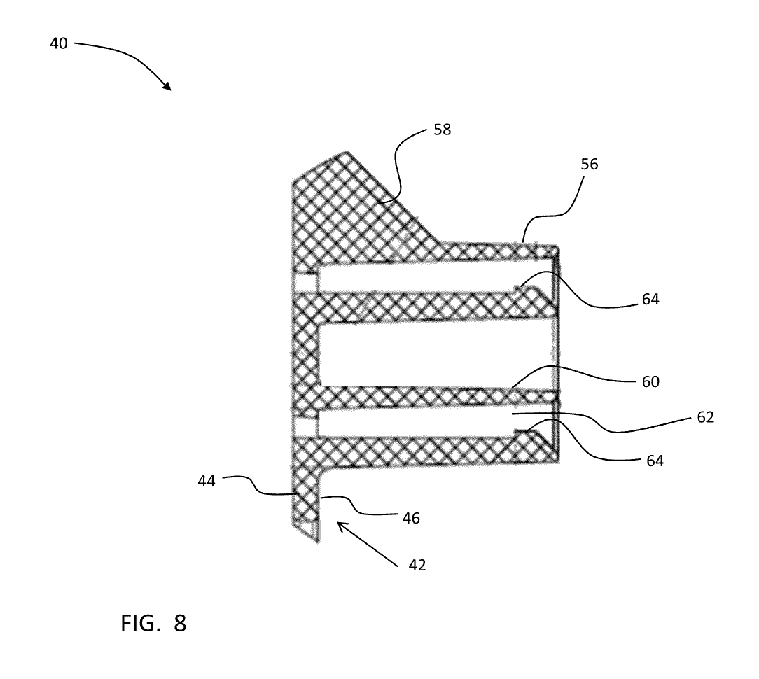

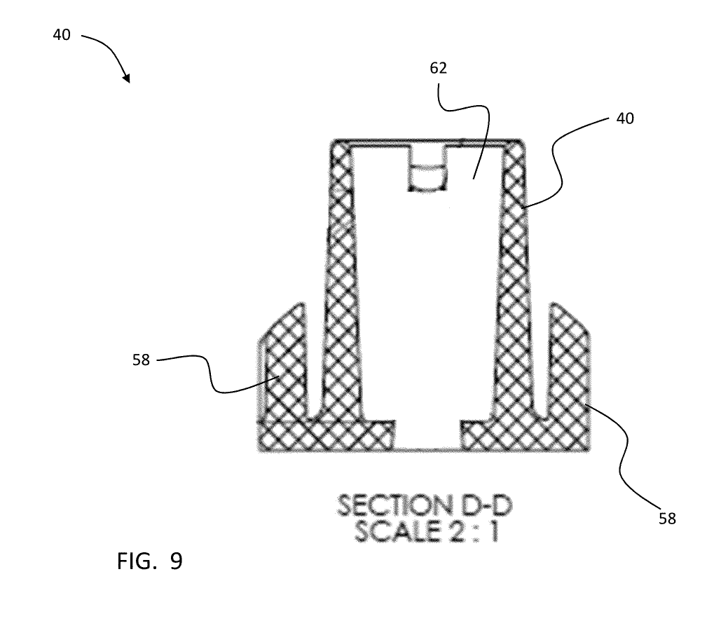

Referring now to FIGS. 3-9, a pole foot 40 connected to the first end 24 of the support pole 22 is illustrated in more detail. The pole foot 40 is configured to distribute the weight applied to the support pole 22 by the webbing straps 30 and the cover (not shown) of the transportation vehicle 10. The pole foot 40 may be formed from any suitable material, including, but not limited to plastic and polymeric material for example. The pole foot 40 includes a base 42 having a first side 44 configured to contact the interior surface or floor 14 of the transportation vehicle 10. Although the illustrated base 42 is generally circular in shape, a base 42 having another shape, such as triangular, rectangular, square, or rhomboid for example, is within the scope of the invention. The width or diameter of the base 42 is substantially larger than the diameter of the support pole 22 such that the forces applied thereto by the anti-pooling system 20 are evenly distributed over the base.

A plurality of substantially identical openings 50 is generally equidistantly positioned about the periphery of the base 42. In the illustrated, non-limiting embodiment, each of the openings 50 is generally round and is configured to removably receive a textured pad 52 (see FIGS.), such as via an interference fit for example. The textured pads 52 are formed from a durable material, for example rubber, and are intended to limit movement of the base 42 relative to the floor 14, as well as to absorb shock. By positioning the textured pads 52 over various areas of the floor 14 during set-up of the anti-pooling system 20, dents, aesthetically displeasing marks, and other damage to the floor 14 as a result of repetitive use may be avoided.

A plurality of elongated slots 54 may also be formed in the base 42. The elongated slots 54 may be substantially similar in size and shape and are configured to receive a plurality of webbing straps, such as straps 30 for example. In such embodiments, the pole foot 40 is configured for use not only at a first end 24 of the support pole 22, but also at a second, opposite end 26 of the support pole 22. When positioned at the second, elevated end 26 of the support pole 22, the pole foot 40 provides a central attachment point and replaces the webbing attachment device 28 in the anti-pooling system 20 (see FIG. 2).

A pole receiver 48, such as integrally formed with the base 42 for example, extends substantially perpendicular from the center of a second, opposite side 46 of the base 42. The pole receiver 48 provides an interface between the pole foot 40 and the support pole 22 of the anti-pooling system 20. The pole receiver 48 is generally cylindrical in shape and includes an outer wall 56 having a diameter complementary to the diameter of the support pole 22 received therein. In the illustrated, non-limiting embodiment, extending outwardly from the outer wall 56 of the pole receiver 48 is at least one rib 58. The one or more ribs 58 are generally equidistantly spaced about the configured to structurally support and stabilize the pole receiver 48 and the support pole 22.

In the illustrated, non-limiting embodiment, the pole receiver 48 includes a cylindrical inner wall 60 arranged concentrically within the cavity 62 defined by the outer wall 56. When the pole foot 40 is connected to a hollow support pole 22, the inner wall 60 extends into the interior (not shown) of the support pole 22 to guide and stabilize the support pole 22 relative to the base 42. At least one of the outer wall 56 and the inner wall 60 may additionally include one or more protrusions 64 extending towards the support pole 22. These protrusions 64 are configured to engage a complementary receiving feature (not shown) formed in the support pole 22, such as a slot or opening for example, to limit rotation of the support pole 22 relative to the pole foot 40. However, a pole receiver 48 having other configurations are also within the scope of the disclosure.

Use of the pole foot 40 in an anti-pooling system 20 is intended to prevent damage to a floor 14 of a transportation vehicle 10 in which the anti-pooling system 20 is mounted by more evenly distributing the load applied thereto by a cover of the transportation vehicle 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A pole foot comprising:
a pole foot base having a first contact surface and a second opposing surface;
a pole receiver extending substantially perpendicularly from the second opposing surface, the pole receiver including a first wall configured to receive a support pole, wherein a width of said pole foot base is substantially larger than a width of said support pole.

2. The pole foot of claim 1, wherein said first wall defines a cavity within which said support pole is received.

3. The pole foot of claim 2, wherein said first wall includes a protrusion substantially complementary to an opening formed in said support pole such that when said protrusion is arranged within said opening, rotation of said support pole relative to the pole foot is limited.

4. The pole foot of claim 2, wherein said pole receiver further comprises a second wall arranged within said cavity, said second wall configured to extend into a hollow interior of said support pole.

5. The pole foot of claim 4, wherein at least one of said first wall and said second wall includes a protrusion substantially complementary to an opening formed in said support pole such that when said protrusion is arranged within said opening, rotation of said support pole relative to the pole foot is limited.

6. The pole foot of claim 1, wherein at least one rib extends from said outer wall of said pole receiver to said pole foot base.

7. The pole foot of claim 1, further comprising at least one textured pad extending through an opening in said pole foot base adjacent said first contact surface.

8. The pole foot according to claim 7, wherein said at least one textured pad is configured to limit movement of the pole foot base relative to an adjacent surface.

9. The pole foot of claim 1, further comprising at least one webbing hole formed in the pole foot base, said at least one webbing hole being configured to receive a webbing strap.

10. The pole foot of claim 1, wherein said pole foot is formed from a plastic material.

11. An anti-pooling system configured to support a cover, comprising:
a support pole;
a first pole foot mounted to a first end of said support pole, said first pole foot including:
a pole foot base having a first contact surface and a second opposing surface;
a pole receiver extending substantially perpendicularly from the second surface, the pole receiver including a first wall configured to receive said support pole, wherein a width of said pole foot base is substantially larger than a width of said support pole.

12. The anti-pooling system of claim 11, further comprising:
at least one webbing hole formed in the pole foot base; and
at least one webbing strap received within said at least one webbing hole.

13. The anti-pooling system of claim 12, further comprising a second pole foot mounted to a second end of said support pole, said second pole foot including:
a pole foot base having a first contact surface and a second opposing surface;
a pole receiver extending substantially perpendicularly from the second surface, the pole receiver including a first wall configured to receive said support pole, wherein a width of said pole foot base is substantially larger than a width of said support pole.

14. The anti-pooling system of claim 13, wherein said first pole foot and said second pole foot are substantially identical.
